(19) United States
(12) Patent Application Publication
(10) Pub. No.: US 2024/0123333 A1
(43) Pub. Date: Apr. 18, 2024

(54) GAMING CONTROL CONSOLE SYSTEM

(71) Applicant: Guangsi Han, San Jose, CA (US)

(72) Inventor: Guangsi Han, San Jose, CA (US)

(21) Appl. No.: 17/966,803

(22) Filed: Oct. 15, 2022

(51) Int. Cl. A63F 13/23; A63F 13/245

(52) U.S. Cl. CPC A63F 13/23; A63F 13/245; A63F 2300/1025; A63F 2300/1062

(57) ABSTRACT

This relates to video game controllers and in particular to video game controllers having a modular interface system which allows the game player to operate the video game controller with a variety of different video gaming platforms having different physical and electrical connectivity requirements.

### BRIEF SUMMARY

This disclosure relates to video game controllers and in particular to video game controllers having a modular interface system which allows the game player to operate the video game controller with a variety of different video gaming platforms having different physical and electrical connectivity requirements.

In the desktop video game industry, there exist multiple types of controllers for gaming platforms—some are attached to a dedicated video game devices integrated with a screen and a single integrated controller, some are attached to desktop video game systems with wired or even cordless controllers that are not integrated into the system as a connected unit. Other controllers attached to desktop game systems are not allowed for replacement of individual separate controllers but rather required the user to use the most generic controller types such as a four-button pad.

The large selection of games of various genres and user interaction requirements leads to the need for quick and easy swapping of various types of user input interfaces that would provide the optimum user experience. This tends to create a poorer user experience when playing games. Without use of dedicated integrated controller types that are best suited for the type or game played, such as joysticks, arrayed control buttons, track balls, and the like, the user suffers from a diminished game experience.

Therefore, it would be advantageous if the video game controller could be readily and easily adapted for use with a variety of different gaming platforms in a cost-effective manner. It would also be advantageous for the video game controller to be upgradeable in order to be used with future gaming platforms that have not yet been designed.

Embodiments of the present disclosure may include a gaming control console system having interchangeable means including. Embodiments may also include a main gaming unit. Embodiments may also include a combination trackball and spinner controller deck. Embodiments may also include an Arcade Stick controller deck. Embodiments may also include a racing wheel with attached foot pedal controller deck.

In some embodiments, the gaming control console system where the main gaming unit may include. Embodiments may also include a receptive port accepting the connection of any individual controller deck. In some embodiments, the gaming control console system where the main gaming unit may include. Embodiments may also include a receptive port accepting the connection of any individual controller deck via electronic contacts.

In some embodiments, the gaming control console system where the main gaming unit may include. Embodiments may also include a receptive port accepting the connection of any individual controller deck via electronic contacts where the contacts may be spring loaded. In some embodiments, the gaming control console system where the main gaming unit may include. Embodiments may also include a receptive port accepting the connection of any individual controller deck via electronic contacts where the connection may be secured by two lock elements that include release buttons. In some embodiments, the gaming control console system where the receptive port permits a user to exchange the desired controller deck based on the input requirements of a game loaded and running on the main gaming unit.

### BRIEF DESCRIPTION OF THE FIGURES

FIG. 1 is a perspective view of the gaming console with different controller attachments.

FIG. 2 is a perspective view of the gaming console with the arcade stick controller.

FIG. 3 is a perspective view of the spring-loaded touch points that connects the controller to the console.

FIG. 4 is a front view of the control deck.

FIG. 5 is a perspective view of the how the arcade controller attaches to the console.

FIG. 6 is a perspective view of the controller and console.

FIG. 7 is a perspective view inside the control deck.

FIG. 8 is a block diagram illustrating a gaming control console system, according to some embodiments of the present disclosure.

FIG. 9 is a block diagram further illustrating the gaming control console system from FIG. 9, according to some embodiments of the present disclosure.

### DETAILED DESCRIPTION

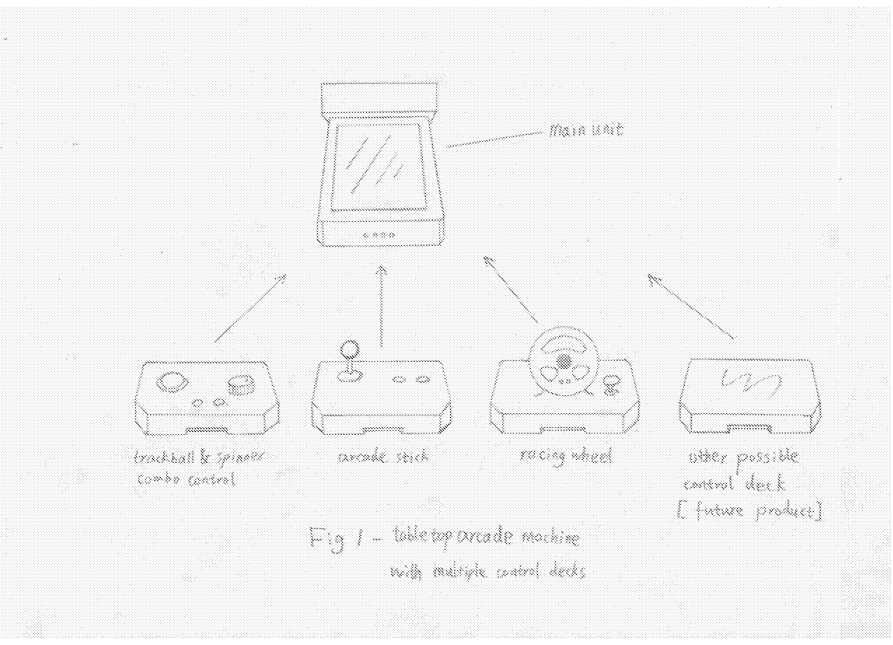

FIG. 1 is a perspective view of the main console and the various controller attachments including a track-ball and spinner controller, arcade stick controller, and racing wheel controller.

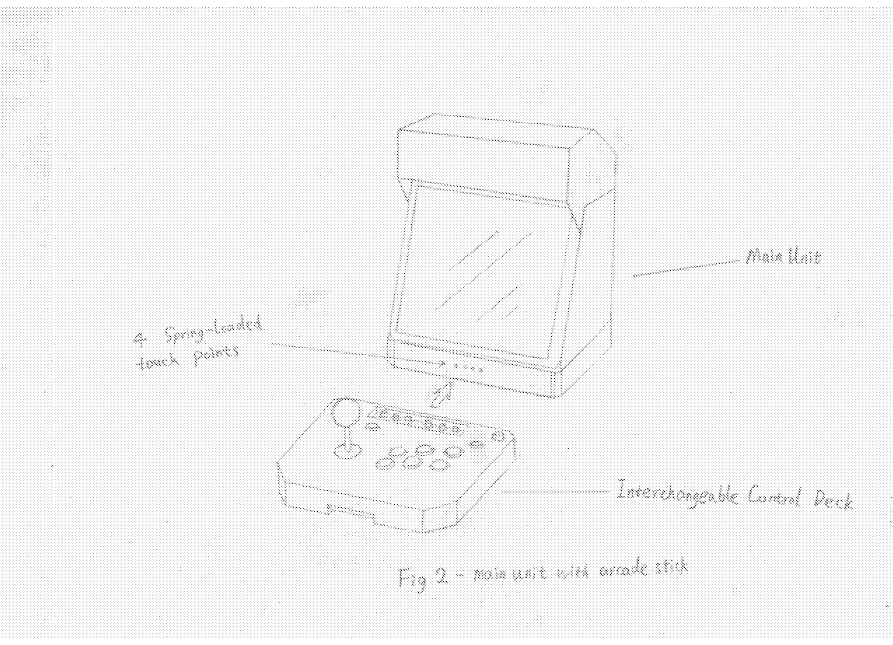

FIG. 2 is a perspective view of the main console with an illustration of how the arcade stick controller attaches to the console via the four spring loaded touch points.

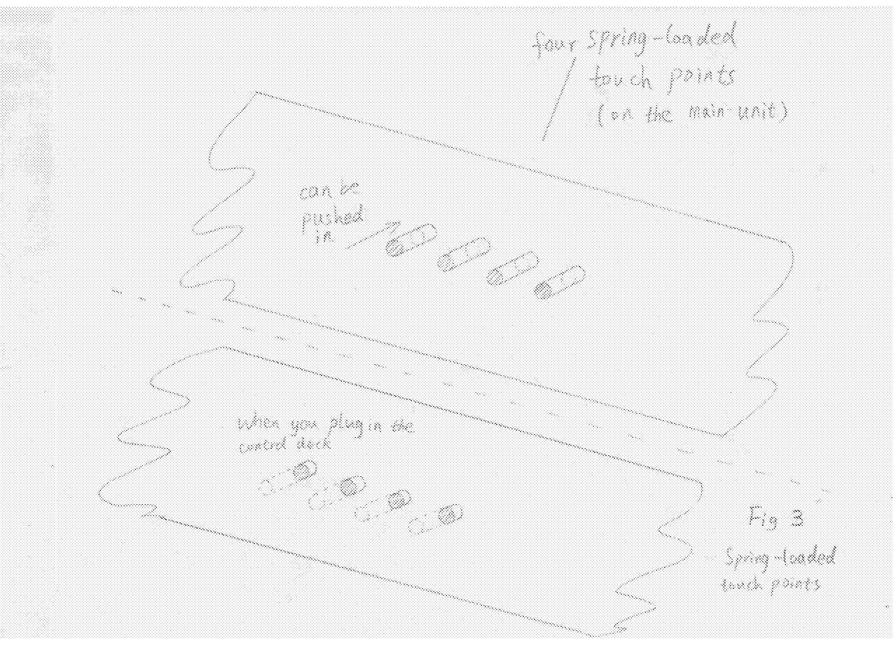

FIG. 3 shows how the spring-loaded touch pins connect the various controllers to the main console.

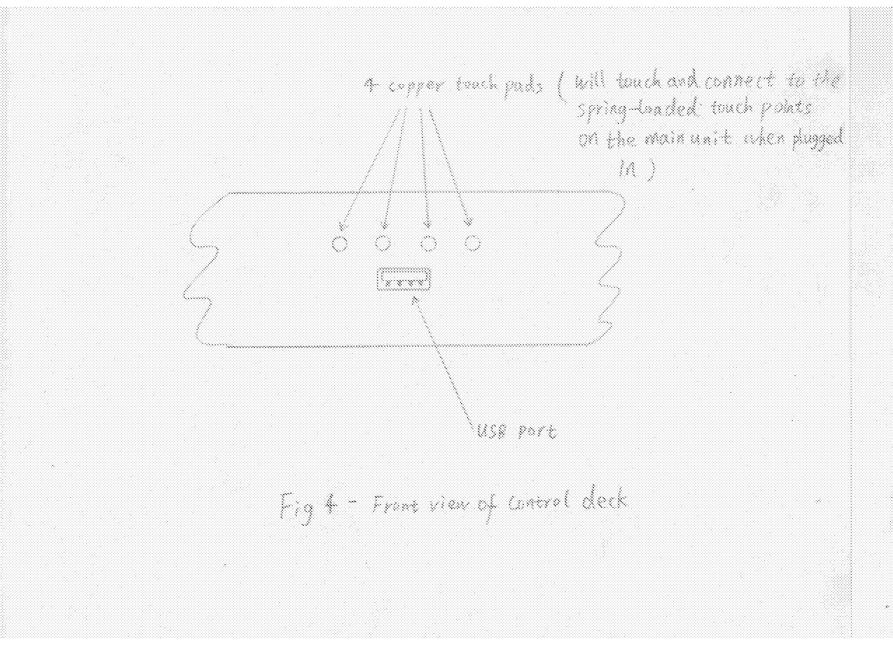

FIG. 4 shows the front view of the control deck. The control deck comprises of four copper touch pads and a USB port on the face plate of the control deck.

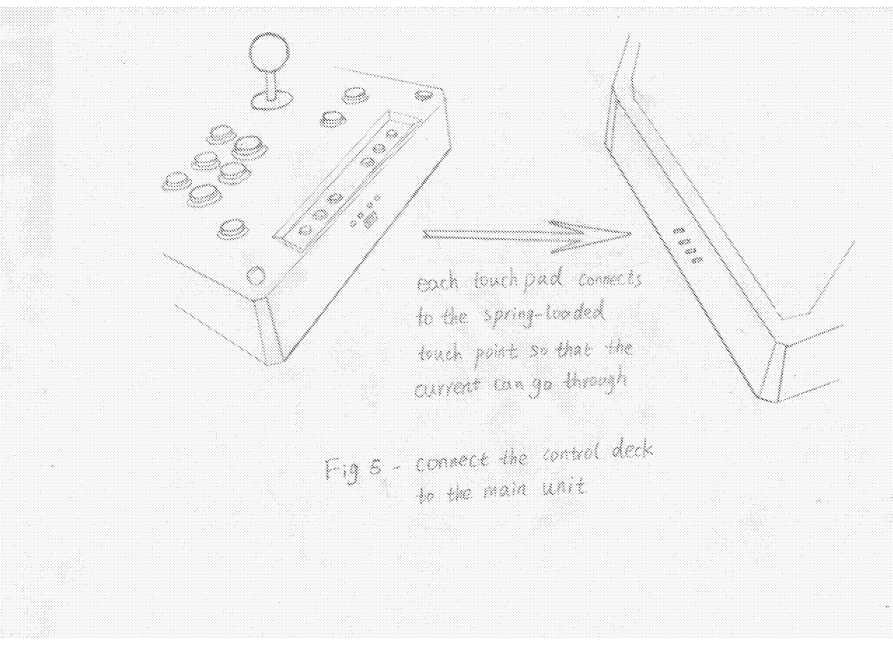

FIG. 5 shows a perspective view of how the controller attaches to the console. The touch pads connect to the spring-loaded touch point, so the current goes through.

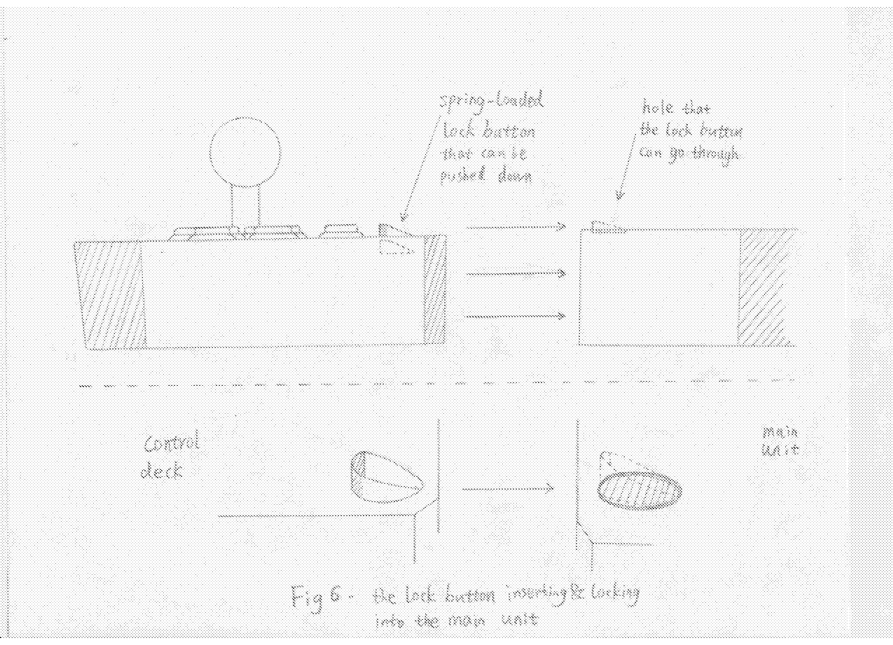

FIG. 6 shows a perspective view of the lock button and how it interacts with the console as to not allow the controller to come loose.

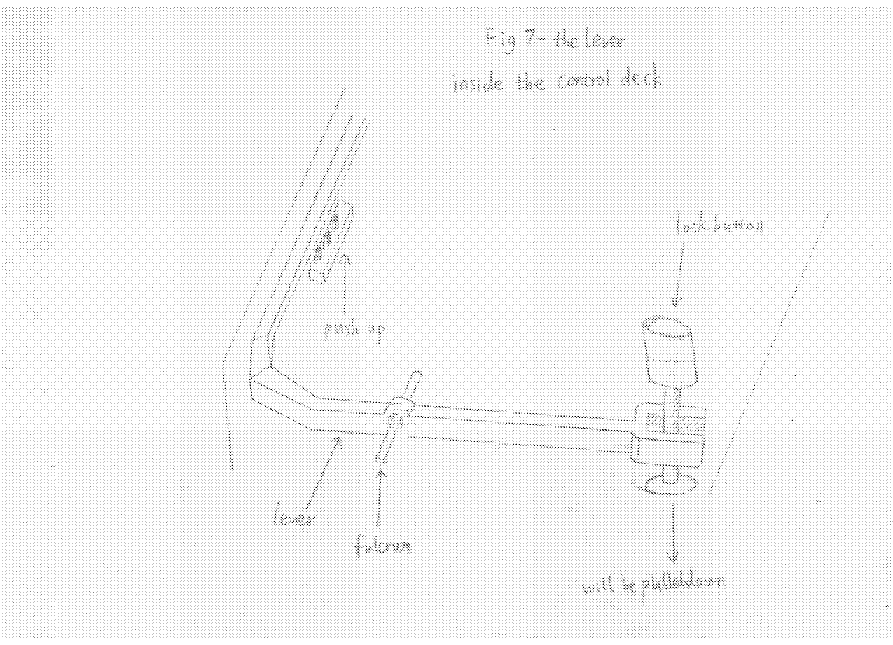

FIG. 7 shows the interior of the control deck and how the lock button interacts with the console.

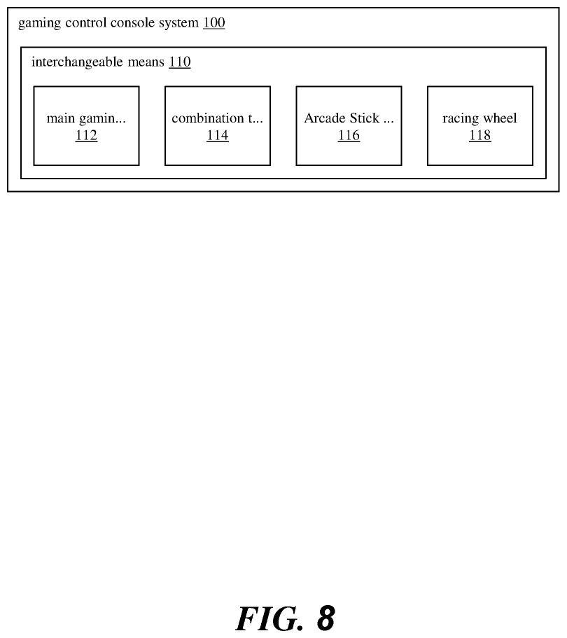

FIG. 8 is a block diagram that describes a gaming control console system 100, according to some embodiments of the present disclosure. In some embodiments, the gaming control console system 100 may include interchangeable means 110. The interchangeable means 110 may include a main gaming unit 112, a combination trackball and spinner controller deck 114, an Arcade Stick controller deck 116, and a racing wheel 118 with attached foot pedal controller deck. In some embodiments, the gaming control console system 100 where the main gaming unit 112. In some embodiments, the gaming control console system 100 where the main gaming unit 112. In some embodiments, the gaming control console system 100 where the main gaming unit 112. In some embodiments, where the receptive port may permit a user to exchange the desired controller deck based on the input requirements of a game loaded and running on the main gaming unit 112.

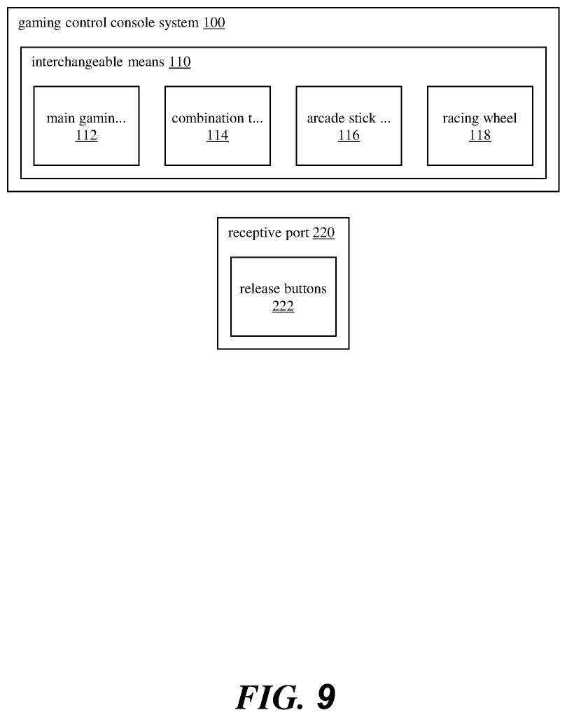

FIG. 9 is a block diagram that further describes the gaming control console system 100 from FIG. 8, according to some embodiments of the present disclosure. In some embodiments, the gaming control console system 100 where the main gaming unit 112. The receptive port 220 may include release buttons 222.

I claim:

1. A gaming control console system having interchangeable means comprising
A main gaming unit;
a combination trackball and spinner controller deck;
An Arcade Stick controller deck; and
a racing wheel with attached foot pedal controller deck.

2. The gaming control console system of claim 1 where the main gaming unit comprises a receptive port accepting the connection of any individual controller deck.

3. The gaming control console system of claim 1 where the main gaming unit comprises a receptive port accepting the connection of any individual controller deck via electronic contacts.

4. The gaming control console system of claim 1 where the main gaming unit comprises a receptive port accepting the connection of any individual controller deck via electronic contacts where said contacts are spring loaded.

5. The gaming control console system of claim 1 where the main gaming unit comprises a receptive port accepting the connection of any individual controller deck via electronic contacts where said connection is secured by two lock elements that include release buttons.

6. The gaming control console system of claim 1 where the receptive port permits a user to exchange the desired controller deck based on the input requirements of a game loaded and running on the main gaming unit.
